(19) United States
(12) Patent Application Publication
(10) Pub. No.: US 2024/0216788 A1
(43) Pub. Date: Jul. 4, 2024

(54) ROULETTE SYSTEM WITH A BONUS EVENT

(71) Applicant: Interblock d.o.o., Las Vegas, NV (US)

(72) Inventor: John Joseph Connelly, Las Vegas, NV (US)

(21) Appl. No.: 18/390,453

(22) Filed: Dec. 20, 2023

Related U.S. Application Data
(60) Provisional application No. 63/477,777, filed on Dec. 29, 2022.

(51) Int. Cl. A63F 5/00

(52) U.S. Cl. CPC A63F 5/0082; A63F 5/007

(57) ABSTRACT

A roulette system including a roulette generator having a number circle corresponding to pockets of a roulette wheel of the roulette generator, a plurality of the pockets of the roulette wheel being identified by a number and a color and one or more pockets being identified by a symbol, a betting layout configured to enable a player to place one or more bets by placing a betting amount on one or more of the numbers, colors and symbols corresponding to the numbers, colors and symbols of the number circle, wherein a payout corresponds to any winning bet and a bonus event system that is triggered when the result of the roulette generator corresponds to the one symbol on the number circle.

### CROSS REFERENCE TO RELATED APPLICATIONS

This application claims benefit under 35 U.S.C. § 119(e) of Provisional U.S. Patent Application No. 63/477,777, filed Dec. 29, 2022, the contents of which is incorporated herein by reference in its entirety.

### TECHNICAL FIELD

The present disclosure relates to gaming apparatus and more particularly to roulette gaming apparatus or systems.

### BACKGROUND

Roulette is a popular wagering game played in casinos and other gaming establishments. In mechanical versions of the game (versus video generated), a roulette ball is launched into a stationary rim having a single angled annular track encircling a spinning roulette wheel. The spinning wheel rotates in the opposite direction of the rotating roulette ball. The roulette ball rotates around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to jump about. Eventually the roulette ball will come to rest in one of the numerous equally spaced apart ball slots located along a circumference of the roulette wheel. Each ball slot among the equally spaced apart ball slots is isolated from adjacent ball slots by separators positioned radially outward and corresponds to a particular number and color located on a number circle adjacent to the ball slots. The particular color and number represent a result for the game cycle that began when the roulette ball was launched.

As the roulette ball comes to rest, indicating a result of the game cycle, a marker (or dolly) may be used to mark a betting area (or layout) of a display or an adjacent physical horizontal surface that is separate from the roulette mechanism. The dolly identifies the result by the number and color on the layout corresponding to the ball slot in which the roulette ball came to rest. Winning and losing bets for that game cycle that had been electronically or physically placed on the betting area prior to a bet close time of that game cycle are then determined according to the result. Once the losing bets are collected and the winning bets are paid, a new game cycle starts.

Although roulette can be a fun and exciting on its own, there have been numerous attempts to add further fun and excitement by modifying aspects of roulette as structured in different parts of the world. Roulette systems may include a number of numbers on the number circle spaced apart and arranged in different manners. The number circles of roulette wheels typically include at least 36 numbers. Some number circles may include additional numbers and the roulette wheels may include a corresponding number of ball slots, which can change the arrangement of the numbers of the number circle. Number circles including an extra number are typically numbered “0”, two extra numbers are typically numbered “0” and “00”, etc. The zeros numbers are typically green and therefore neither even nor odd. FIG. 1 is an exemplary illustration of a prior art roulette wheel system 10, including a roulette wheel 12 that spins in one direction and is surrounded by a stationary annular track 14 within which a ball 16 is spun in the opposite direction of the roulette wheel's spin. A surface of the roulette wheel 12 slopes toward that ball slots 18, which are surrounded by the number circle 19. The number circle illustrated corresponds to a 37 number roulette system that includes 36 numbered ball slots with one added “0” ball slot.

### SUMMARY

A roulette system including a roulette generator having a number circle corresponding to pockets of a roulette wheel of the roulette generator, 36 of the pockets of the roulette wheel being identified by a number and a color and one or more pockets being identified by a symbol, a betting layout configured to enable a player to place one or more bets by placing a betting amount on one or more of the numbers, colors and symbol(s) corresponding to the numbers, colors and symbol(s) of the number circle, wherein a payout corresponds to any winning bet and a bonus event system that is triggered when the result of the roulette generator corresponds to one symbol on the number circle.

### BRIEF DESCRIPTION OF THE DRAWINGS

FIG. 1 is an illustration of a prior art roulette wheel.

FIG. 2 is an illustration of a number circle including a series of symbols in accordance with an embodiment.

FIG. 3 is an illustration of a table/betting layout based on the number circle of FIG. 2 in accordance with an embodiment.

FIG. 4. is an illustration of a multiplier circle in accordance with an embodiment.

FIG. 5 is an illustration of a dual roulette generator system incorporating the multiplier circle of FIG. 4 in a separate roulette generator in accordance with an embodiment.

FIG. 6 is an illustration of a roulette system with the multiplier circle of FIG. 4 incorporated into the same roulette generator used for the regular roulette game in accordance with an embodiment.

FIG. 7 is a block diagram of an embodiment of a computer system.

### DETAILED DESCRIPTION OF ILLUSTRATIVE EMBODIMENTS

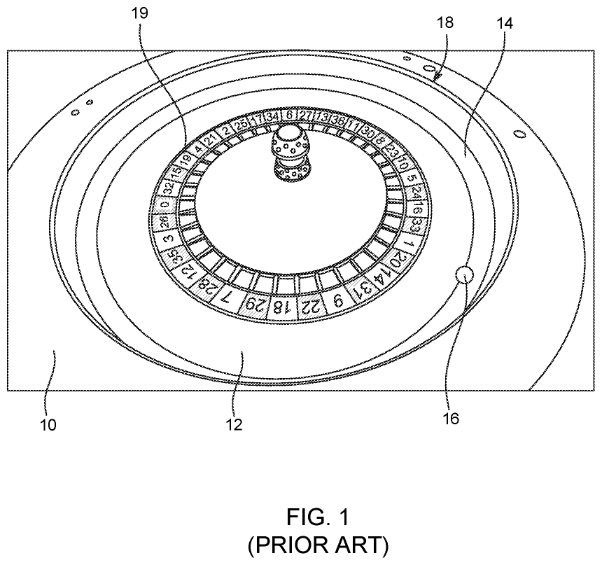

Most roulette systems have a stationary rim and base and a rotating roulette wheel positioned in the upper middle of the base. The roulette wheel includes a number of ball slots or pockets configured to hold the roulette ball at the end of a game cycle. A number between 1 and 36 (and also 0, 00, 000 and 0000 on some roulette wheels) and a color (typically green for 0's and alternating between red and black for the other numbers) are assigned to each of the ball slots or pockets. The stationary rim includes an angled annular track in which one or more roulette balls manually spin. At the beginning of a game cycle with a single roulette ball, typically after further bets are closed, a dealer will either manually spin the roulette ball in the track or the roulette ball will be mechanically launched from a launch tube. The roulette ball spins in the opposite direction of the rotating roulette wheel. When the roulette ball eventually exits the track, the ball will ultimately land in one of the ball slots or pockets indicating the result and the end of that game cycle. FIG. 1 is an illustration of an exemplary prior art roulette system with 37 pockets with the numbers 0-36 on the number circle.

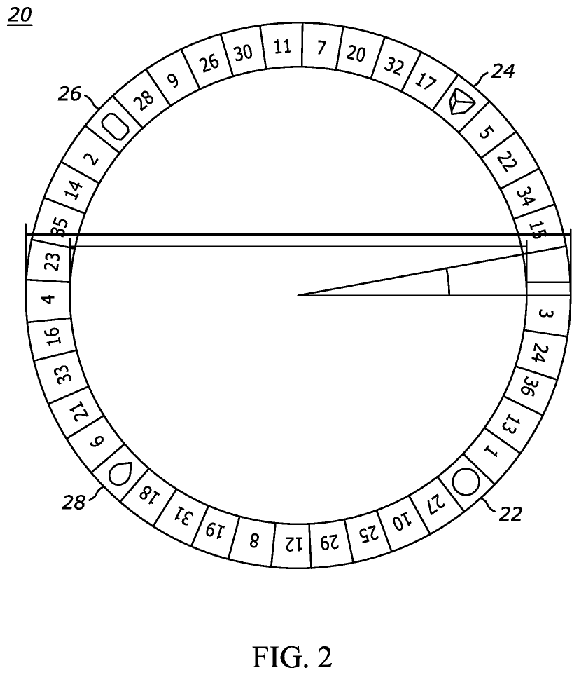

FIG. 2 is an illustration of number circle 20 that includes a number of symbols in addition to the numbers 1-36 of the standard roulette system. The number circle 20 as shown includes an additional triangular dimensional indicator between the numbers 15 and 3 that would not be part of the actual number circle, which would include just the numbers. The number circle 20 may be designed for use in a roulette system, i.e., rotating system, ball launcher, etc., that includes 40 pockets instead of some lesser number of pockets of existing roulette systems. Instead of including pockets that correspond to 0, 00, 000 and 0000, the pockets correspond to the four even spaced apart symbols 22, 24, 26 and 28. In an embodiment, the symbols may correspond to valuable items, such as a diamond, symbol 22, a ruby, symbol 24, an emerald, symbol 26, and a sapphire, symbol 28, but the symbols are not limited to this embodiment and could simply be different colors other than red and black and include any of a number of different symbols, designs or images. A number circle with 40 numbers and symbols and a roulette wheel with a corresponding number of pockets is not required. The number circle could include one or more symbols and one or more corresponding pockets and still be consistent with the current disclosure.

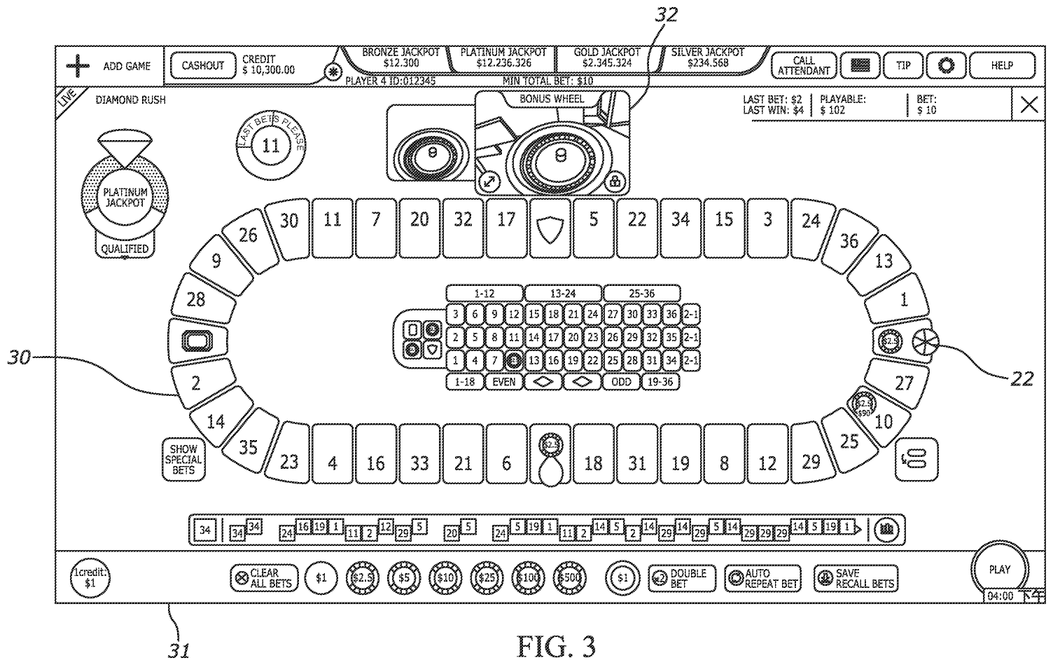

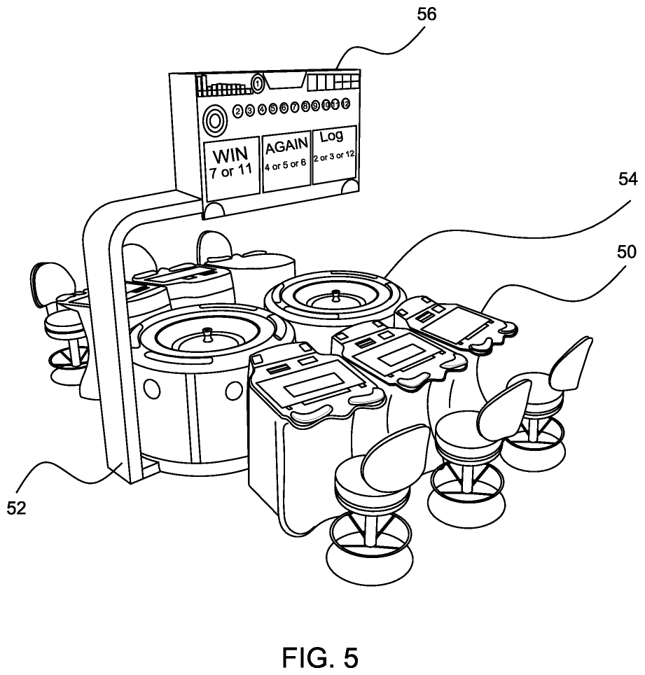

FIG. 3 is an illustration of a table/betting layout 30 that corresponds to the number circle 20 of FIG. 2. The betting layout 30 may be electronically displayed or imaged onto a physical table positioned near the roulette wheel that includes the number circle 20. As illustrated in FIG. 3, the betting layout 30 is electronic such that a player may move representations of chips from a lower tray area 31 to different portions of the layout 30 in order to make one or more bets. The betting layout 30 may be displayed on the display of a player station 50 as shown in FIG. 5 and further described herein. The possible bets may include standard bets of a roulette system, such as straight up (i.e., a bet placed on a single number), red/black (i.e., a bet placed on either red or black), odd/even (i.e., a bet placed on the ball landing on either an odd number or an even number), high/low (i.e., a bet placed number between 1-18 or between 19-36), and many more complicated bets corresponding to various combinations, colors, numbers and symbols. Each of the different bets have different odds associated with winning/losing and payouts that correspond. A straight up bet on a roulette system having a roulette wheel with 37 pockets, one of which is 0, for example, has odds against winning of 36:1 and a payout of 35:1, meaning for each dollar bet, the payout is multiplied by 35. A straight up bet on a roulette system having a roulette wheel with 38 pockets, two of which are 0 and 00, would have odds against winning of 37:1 because of the additional pocket but the same payout. Different odds and payouts may also be used. For example, a 40-pocket roulette wheel may have even higher odds to hit a straight bet, which might lead to variations in the pay table, such as paying 36:1 instead of 35:1.

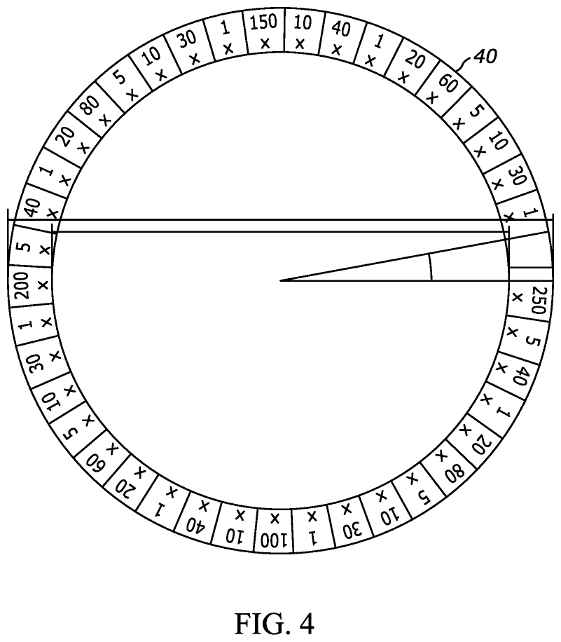

In the betting layout 30, if a bet is placed on one of the symbols, such as symbol 22, and the ball lands on that symbol to conclude the result of a roulette game, a bonus event may be activated, such as the bonus wheel 32 illustrated in FIG. 3. As illustrated, the bonus wheel 32 is a picture-in-picture display or either a live wheel located physically elsewhere or a computer-generated video display of the wheel. The bonus event 32 may be implemented in a number of different ways as further described herein, each of which includes a multiplier circle 40 as illustrated in FIG. 4. Like the number circle 20, the multiplier circle 40 includes up to 40 numbers (the same as the number circle 20) arranged around the circle 40 that correspond to different multipliers, ranging from ×1 to ×250, that may be used to multiply the winning payout. Like the number circle 20, the number circle 40 as shown includes a triangular dimensional indicator that would not be part of the actual number circle, which would include just the numbers and symbols. As illustrated in FIG. 4, there are 8×1 multiples, 6×5 multiples, 6×10 multiples, 4×20 multiples, 4×30 multiples, 4×40 multiples, 2×60 multiples, 2×80 multiples, and 1 each of ×100, ×150, ×200 and ×250, although other arrangements of multiples and different values may be utilized.

One implementation of the bonus event is the embodiment illustrated in FIG. 5. A number of players may be seated at player stations 50 that each include a display screen for interacting with the roulette system, such as shown in FIG. 3, as well as other standard components of a slot-like machine, such as a currency detector, a card reader, a payout printer, speakers, lights, etc. In the embodiment of FIG. 5, there are two roulette systems or generators, with a first roulette generator 52 for playing the regular roulette game that includes the number circle 20 with the symbols 22, 24, 26 and 28, and a second roulette generator 54 for playing the bonus event. A community display 56 may be positioned over the two roulette generators for displaying the results of the first roulette generators 52 and for displaying the result of the second roulette generator 54 in the event there is a bonus event.

In an embodiment, if the result of the first roulette generator 52 is the ball landing on a pocket corresponding to one of the symbols 22, 24, 26 or 28, that result would be illustrated on the community display 56 and the second roulette generator 54 would be activated, i.e., the roulette wheel would be spun and the ball would be launched and once the ball landed in a pocket, the result of the multiplier circle 40 would be applied to the result of the first roulette generator 52. For example, if $10 had been played on symbol 22 and the ball landed in the pocket corresponding to symbol 22, the second roulette generator 54 would be spun and if the ball landed in the pocket corresponding to a multiplier of ×80, then the payout would be $800. In an embodiment, the second roulette generator 54 may be spun if the ball landed in a pocket of the first roulette generator 52 corresponding to a symbol even if no bet had been placed on that symbol so as to show players what might have happened if they had bet on a symbol.

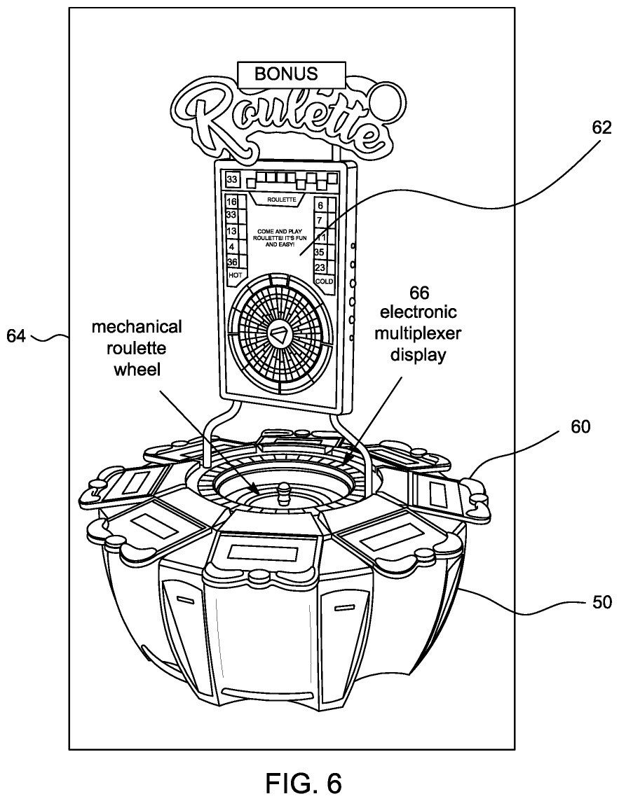

A second implementation of the bonus event is the embodiment illustrated in FIG. 6, in which a single roulette generator 60 is surrounded by a number of player stations 50 with a community display 62 positioned over the roulette generator 60. In the embodiment the mechanical roulette wheel 64 operates in the same manner as the first roulette generator 52, but in this case the multiplier circle is an electronic multiplier display 66. If the result of the mechanical roulette wheel 64 is the ball landing on a pocket corresponding to one of the symbols 22, 24, 26 or 28, that result would be illustrated on the community display 62 and the electronic multiplier display 66 would be activated. Activation of the electronic multiplier display 66 may include a light and sound event meant to create the impression that the multiplier circle of the electronic multiplier display 66 is rotating, i.e., the lights would spin around the multiplier circle, and stop on one multiplier to indicate the result. The result may be predetermined by a random number generator of the roulette generator 60.

In the second implementation, because the electronic multiplier display 66 is electronic, it could also be changed so that different multiplier are applied during different bonus events, or the multipliers are arranged in different ways around the multiplier circle. Such changes may be generated as a result of the random number generator of the roulette generator 60 before each game is started.

In a further embodiment, the number circle and the multiplier display may be electronic and displayed in the same physical space by one or more display devices located under the roulette wheel or projected onto the roulette wheel from somewhere above the roulette wheel. During the regular game, the number circle may be displayed around the roulette wheel. When the roulette ball lands in the pocket corresponding to a symbol, and after displaying the results on the community display, the display of the number circle could be replaced with the display of the multiplier display and then bonus game is run. When the bonus game is over and the result displayed on the community screen and bets are resolved, the display could switch back to the regular game.

In a further embodiment the multiplier circle may be incorporated into the roulette wheel in the same manner as the number circle. In such an embodiment, if the result of the mechanical roulette wheel is the ball landing on a pocket corresponding to one of the symbols 22, 24, 26 or 28, that result would be illustrated on a community display and the roulette wheel could be automatically spun again with a second ball being launched as the bonus event. Whatever pocket in which the second ball spins would determine the result of the bonus event based on the multiplier corresponding to that pocket.

In another embodiment, the roulette system with a bonus event may be operated in a physical location remote from a player placing bets on the roulette system. From an Internet connected computer in communication with the roulette system, the player may access a betting layout configured to enable the player to place one or more bets by placing a betting amount on one or more of the numbers, colors and symbols corresponding to the numbers, colors and symbols of the number circle of the roulette wheel. A payout may correspond to any winning bet. A bonus event system may be triggered when a bet is placed on one symbol in the betting layout and the result corresponds to the one symbol on the number circle. The bonus event may have the effect of multiplying the payout.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

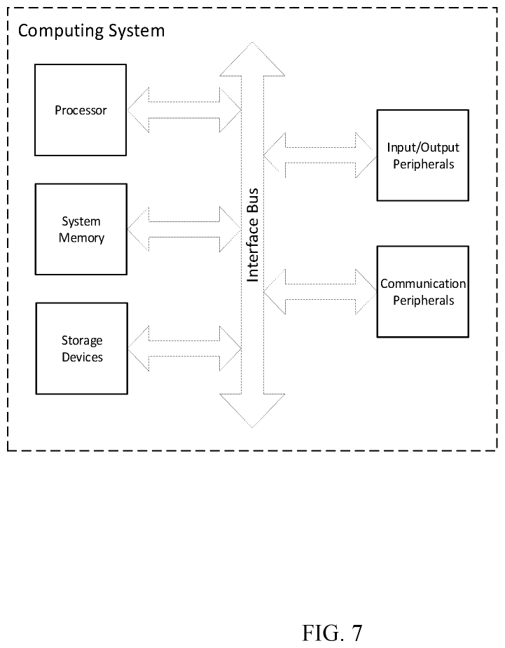

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 7 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

In an embodiment, a roulette system with a bonus event may comprise: a roulette mechanism having a base, an annular stationary rim mounted on the base, the stationary rim having a central opening and an upwardly curved face around which a roulette ball travels, a rotating roulette wheel configured to spin in a first direction and positioned in the central opening of the stationary rim and supported by the base, the roulette wheel including a number of pockets configured to hold the roulette ball after traveling from the curved face onto the roulette wheel, a number circle including numbers, colors and one or more symbols corresponding to the pockets, wherein a plurality of the pockets are identified by a number and a color and one or more pockets are identified by a symbol, and a roulette ball launching system configured to launch the roulette ball spinning around the stationary rim in a second direction, wherein a result is determined by the number or the symbol corresponding to a pocket in which the roulette ball stops after traveling onto the roulette wheel; a betting layout configured to enable a player to place one or more bets by placing a betting amount on one or more of the numbers, colors and symbols corresponding to the numbers, colors and symbols of the number circle, wherein a payout corresponds to any winning bet; and a bonus event system that is triggered when the result corresponds to one symbol on the number circle.

In the embodiment, wherein the bonus event system includes a multiplier of the bet on a symbol when the result corresponds to the symbol on the number circle.

In the embodiment, wherein the multiplier is determined based on a multiplier circle that includes a multiplier number that corresponds to each of the pockets.

In the embodiment, wherein the bonus event system includes a second roulette mechanism having a second base, a second annular stationary rim mounted on the second base, the second stationary rim having a second central opening and a second upwardly curved face around which a second roulette ball travels, a second rotating roulette wheel configured to spin in the first direction and positioned in the second central opening of the second stationary rim and supported by the second base, the second roulette wheel including a second number of pockets configured to hold the second roulette ball after traveling from the second curved face onto the second roulette wheel, a multiplier circle that includes a multiplier number that corresponds to each of the second pockets, and a second roulette ball launching system configured to launch the second roulette ball spinning around the second stationary rim in the second direction, wherein a second result is determined by the multiplier number corresponding to a second pocket in which the second roulette ball stops after traveling onto the second roulette wheel, and wherein the second result multiplies the bet by the multiplier number that corresponds to the second pocket.

In the embodiment, further comprising a plurality of player stations configured around the base and the second base, each of the player stations including a display for displaying the betting layout and enabling the player to place the one or more bets.

In the embodiment, further comprising a community display visible from each of the plurality of player stations for displaying the result and the second result.

In the embodiment, wherein the bonus event system includes an electronic multiplier display that includes a plurality of multiplier numbers and wherein a randomly selected multiplier number among the plurality of multiplier numbers determines a bonus event result, wherein the bet on the symbol is multiplied by the randomly selected multiplier number.

In the embodiment, wherein the plurality of multiplier numbers are arranged on a multiplier circle that includes a multiplier number that corresponds to each of the pockets.

In the embodiment, wherein the multiplier circle encircles the roulette wheel, further comprising a plurality of player stations configured around the base, each of the player stations including a display for displaying the betting layout and enabling the player to place the one or more bets.

In the embodiment, further comprising a community display visible from each of the plurality of player stations for displaying the result and the bonus event result.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A roulette system with a bonus event, comprising:
a roulette mechanism having a base, an annular stationary rim mounted on the base, the stationary rim having a central opening and an upwardly curved face around which a roulette ball travels, a rotating roulette wheel configured to spin in a first direction and positioned in the central opening of the stationary rim and supported by the base, the roulette wheel including a number of pockets configured to hold the roulette ball after traveling from the curved face onto the roulette wheel, a number circle including numbers, colors and one or more symbols corresponding to the pockets, wherein a plurality of the pockets are identified by a number and a color and one or more pockets are identified by a symbol, and a roulette ball launching system configured to launch the roulette ball spinning around the stationary rim in a second direction, wherein a result is determined by the number or the symbol corresponding to a pocket in which the roulette ball stops after traveling onto the roulette wheel;
a betting layout configured to enable a player to place one or more bets by placing a betting amount on one or more of the numbers, colors and symbols corresponding to the numbers, colors and symbols of the number circle, wherein a payout corresponds to any winning bet; and
a bonus event system that is triggered when the result corresponds to the one symbol on the number circle.

2. The roulette system of claim 1, wherein the bonus event system includes a multiplier of the bet when the result corresponds to the one symbol on the number circle.

3. The roulette system of claim 2, wherein the multiplier is determined based on a multiplier circle that includes a multiplier number that corresponds to each of the pockets.

4. The roulette system of claim 1, wherein the bonus event system includes a second roulette mechanism having a second base, a second annular stationary rim mounted on the second base, the second stationary rim having a second central opening and a second upwardly curved face around which a second roulette ball travels, a second rotating roulette wheel configured to spin in the first direction and positioned in the second central opening of the second stationary rim and supported by the second base, the second roulette wheel including a second number of pockets configured to hold the second roulette ball after traveling from the second curved face onto the second roulette wheel, a multiplier circle that includes a multiplier number that corresponds to each of the second pockets, and a second roulette ball launching system configured to launch the second roulette ball spinning around the second stationary rim in the second direction, wherein a second result is determined by the multiplier number corresponding to a second pocket in which the second roulette ball stops after traveling onto the second roulette wheel, and wherein the second result multiplies the bet by the multiplier number that corresponds to the second pocket when the bet was placed on the one symbol on the number circle.

5. The roulette system of claim 4, further comprising a plurality of player stations configured around the base and the second base, each of the player stations including a display for displaying the betting layout and enabling the player to place the one or more bets.

6. The roulette system of claim 5, further comprising a community display visible from each of the plurality of player stations for displaying the result and the second result.

7. The roulette system of claim 1, wherein the bonus event system includes an electronic multiplier display that includes a plurality of multiplier numbers and wherein a randomly selected multiplier number among the plurality of multiplier numbers determines a bonus event result, wherein the bet is multiplied by the randomly selected multiplier number when the bet was placed on the one symbol on the number circle.

8. The roulette system of claim 7, wherein the plurality of multiplier numbers are arranged on a multiplier circle that includes a multiplier number that corresponds to each of the pockets.

9. The roulette system of claim 8, wherein the multiplier circle encircles the roulette wheel, further comprising a plurality of player stations configured around the base, each of the player stations including a display for displaying the betting layout and enabling the player to place the one or more bets.

10. The roulette system of claim 9, further comprising a community display visible from each of the plurality of player stations for displaying the result and the bonus event result.

11. The roulette system of claim 1, wherein the number circle corresponds to 40 pockets including 4 symbols.
